(19) United States
(12) Patent Application Publication
(10) Pub. No.: US 2025/0173848 A1
(43) Pub. Date: May 29, 2025

(54) METHOD AND SYSTEM FOR TAMPERING DETERMINATION

(71) Applicant: MOTOROLA SOLUTIONS, INC., CHICAGO, IL (US)

(72) Inventors: SIEW IM LOW, PULAU PINANG (MY); ANUP SHINDE, PULAU PINANG (MY); KHAIRUL AZHAR ABU BAKAR, KEPALA BATAS (MY); KIAM BENG LOH, SIMPANG AMPAT (MY)

(21) Appl. No.: 18/519,206

(22) Filed: Nov. 27, 2023

(51) Int. Cl. G06T 7/00; G06F 16/787; G06F 21/64; G06T 7/20

(52) U.S. Cl. CPC G06T 7/0002; G06F 16/787; G06F 21/64; G06T 7/20; G06T 2207/10016; G06T 2207/30232

(57) ABSTRACT

A method and system for tampering determination is disclosed. The method includes analyzing video captured by a body worn camera. The method also includes generating a tampering score for a video irregularity present in the video. The tampering score is generated based on inputting values of variables that correspond to a plurality of tamper determination factors into a formula. When the tampering score satisfies a threshold condition corresponding to deliberate tampering, flag (indicating that deliberate action of a person caused the video irregularity) is stored in non-volatile storage.

### BACKGROUND

On-duty police officers and security guards are often equipped with Body Worn Cameras (BWCs) to capture on-scene video, thereby enhancing available information and evidence associated with incidents at which the officers and guards attend. A BWC's view might be blocked unintentionally during video capture, or alternatively the camera's view might be obscured deliberately if someone tries to turn off or put away the BWC to prevent from it from capturing video of some illegal activity (such as, for example, a bribery attempt, a leaking of information, or a cover up of some discrimination bias).

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a mobile video recording device in accordance with example embodiments.

FIG. 2 is a flow chart illustrating a computer-implemented method in accordance with an example embodiment.

FIGS. 3A-3B is a table showing, in accordance with some examples of the computer-implemented method of FIG. 2, tamper scoring for different types of video irregularity occurrences.

FIG. 4 shows an example incident scene in accordance with an example embodiment.

FIG. 5 is a block diagram showing the mobile video recording device of FIG. 1 communicatively coupled to a server system in accordance with an example embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with one example embodiment, there is provided a computer-implemented method that includes analyzing video captured by a body worn camera. The video includes an earliest-in-time video frame and a last-in time video frame that are captured at times t and t+Δt respectively. The analyzing including employing at least one processor to make an initial determination that, for a time period in-between the times t and t+Δt, a video irregularity (more specifically, a video gap or a video obscuration) exists in the video. The computer-implemented method also includes generating, using the at least one processor, a tampering score for the video irregularity. The tampering score is generated based on inputting values of variables that correspond to a plurality of tamper determination factors into a formula. The tamper determination factors include: one or more causes of the video irregularity; and one or more of at least one first factor directly perceivable from the video and at least one second factor not directly perceivable from the video. When the tampering score satisfies a threshold condition corresponding to deliberate tampering, a flag is stored in non-volatile storage that indicates that deliberate action of a person caused the video irregularity.

In accordance with another example embodiment, there is provided a system that includes at least one processor and an at least one electronic storage medium storing program instructions that when executed by the at least one processor cause the at least one processor to perform analyzing video captured by a body worn camera. The video includes an earliest-in-time video frame and a last-in time video frame that are captured at times t and t+Δt respectively. The analyzing includes making an initial determination that, for a time period in-between the times t and t+Δt, a video irregularity (more specifically, a video gap or a video obscuration) exists in the video. The executing of the program instructions by the at least one processor further causes generating a tampering score for the video irregularity. The tampering score is generated based on inputting values of variables that correspond to a plurality of tamper determination factors into a formula. The tamper determination factors include: one or more causes of the video irregularity; and one or more of at least one first factor directly perceivable from the video and at least one second factor not directly perceivable from the video. When the tampering score satisfies a threshold condition corresponding to deliberate tampering, a flag is caused to be stored in non-volatile storage. The flag indicates that deliberate action of a person caused the video irregularity.

Each of the above-mentioned embodiments will be discussed in more detail below, starting with example system and device architectures of the system in which the embodiments may be practiced, followed by an illustration of processing blocks for achieving an improved technical method, device, and system for tampering determination.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

The meaning of the term “video obscuration” as used herein includes the blocking out of object(s) and/or activity occurring within the Field Of View (FOV) of a video camera, but the meaning of this term also includes other video content-impacting occurrences including unexpected or unusual repositioning of the FOV of a video camera, full or partial muting of audio captured simultaneously with same device-video capture (even when the images of that video are as expected), video degradation due to some video camera malfunction, etc.

Further advantages and features consistent with this disclosure will be set forth in the following detailed description, with reference to the figures.

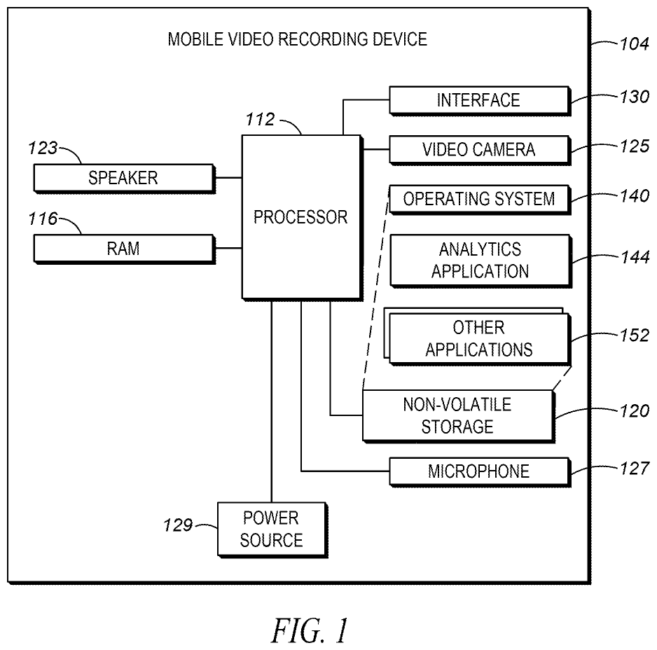

Referring now to the drawings, and in particular FIG. 1 which is a block diagram of a mobile video recording device 104 within which methods in accordance with example embodiments can be carried out. In some example embodiments, the mobile video recording device 104 is, for example, a dedicated BWC device or, alternatively, a mobile electronics device that can be optionally body worn (with a suitable body attachment accessory) such as, for example, a tablet, a phablet, a smart phone or a personal digital assistant (PDA).

The illustrated mobile video recording device 104 includes at least one processor 112 that controls the overall operation of the mobile video recording device. The processor 112 interacts with various subsystems such as, for example, random access memory (RAM) 116, non-volatile storage 120, speaker 123, video camera 125 and microphone 127. In some examples, the video camera 125 may be optionally integrated into a housing of the mobile video recording device 104 (any suitable device components like, for instance, the speaker 123 and the microphone 127, may be optionally integrated into the housing of the mobile video recording device 104). Also, those skilled in the art will appreciate that some of the illustrated device components of the mobile video recording device 104 are optional device components such as, for example, the speaker 123 and the microphone 127.

The illustrated mobile video recording device 104 also includes a power source 129 which provides operating power within the mobile video recording device 104. In some examples, the power source 129 includes one or more batteries, a power supply with one or more transformers, etc.

The illustrated mobile video recording device 104 also includes interface 130. The interface 130 may include hardware, software, or both providing one or more interfaces for communication (such as, for example, packet-based communication) among the mobile video recording device 104, other computing devices similar to the mobile video recording device 104, any suitable networks, any suitable network devices, and/or any other suitable computer systems. As an example and not by way of limitation, the interface 130 may include a Network Interface Controller (NIC) or network adapter for communicating with an Ethernet or other wire-based network and/or a Wireless NIC (WNIC) or wireless adapter for communicating with a wireless network. In at least one example consistent with the example embodiment of FIG. 1, the interface 130 may include a USB port to support USB-compliant communications.

In some examples, the interface 130 comprises one or more radios coupled to one or more physical antenna ports. Depending on the example implementation, the interface 130 may be any type of interface suitable for any type of suitable network with which the mobile video recording device 104 is used. As an example and not by way of limitation, the mobile video recording device 104 can communicate with an ad-hoc network, a Personal Area Network (PAN), a Local Area Network (LAN), a Wide Area Network (WAN), a Metropolitan Area Network (MAN), or one or more portions of the Internet or a combination of two or more of these. One or more portions of one or more of these networks may be wireless. As an example, the mobile video recording device 104 may be capable of communicating with a Wireless PAN (WPAN) (such as, for example, a BLUETOOTH WPAN), a WI-FI™ network, a WI-MAX™ network, a Long-Term Evolution (LTE) network, an LTE-A network, a cellular telephone network (such as, for example, a Global System for Mobile Communications (GSM) network), or any other suitable wireless network or a combination of two or more of these. The mobile video recording device 104 may include any suitable interface 130 for any one or more of these networks, where appropriate.

In some examples, the interface 130 may include one or more interfaces for one or more external I/O devices. These external I/O devices may include, for instance, a selected one or more of a keyboard, mouse, touch pad and roller ball, etc. An external I/O device may, and not by way of limitation, be any suitable input or output device, including alternatives more external in nature than other input devices (or output devices) herein mentioned (also, some combination of two or more of these is also contemplated). An external I/O device may include one or more sensors. Particular examples may include any suitable type and/or number of I/O devices and any suitable type and/or number of interfaces 130 for them. Where appropriate, the interface 130 may include one or more drivers enabling the processor 112 to drive one or more of these external I/O devices. The interface 130 may include one or more interfaces 130, where appropriate.

Still with reference to the mobile video recording device 104, operating system 140 and various software applications used by the processor 112 are stored in the non-volatile storage 120. The non-volatile storage 120 is, for example, one or more hard disks, solid state drives, or some other suitable form of computer readable medium that retains recorded information after the mobile video recording device 104 is turned off. Regarding the operating system 140, this includes software that manages computer hardware and software resources of the mobile video recording device 104 and provides common services for computer programs. Also, those skilled in the art will appreciate that the operating system 140, analytics application 144, and other applications 152, or parts thereof, may be temporarily loaded into a volatile store such as the RAM 116. The processor 112, in addition to its operating system functions, can enable execution of the various software applications on the mobile video recording device 104.

Regarding the analytics application 144, this carries out video and/or audio analytics. In some examples, the analytics application 144 may include one or more suitable learning machines to facilitate the video and/or audio analytics. Those skilled in the art will appreciate that the analytics application 144 need not necessarily reside within the mobile video recording device 104, and instead one alternative may be implementing similarly purposed analytics outside of the mobile video recording device 104 such as, for example, within one or more servers. Also, in at least one example, the analytics application 144 may operationally execute on live BWC video streams with comparison to video footages and/or media stored in non-volatile or volatile storage.

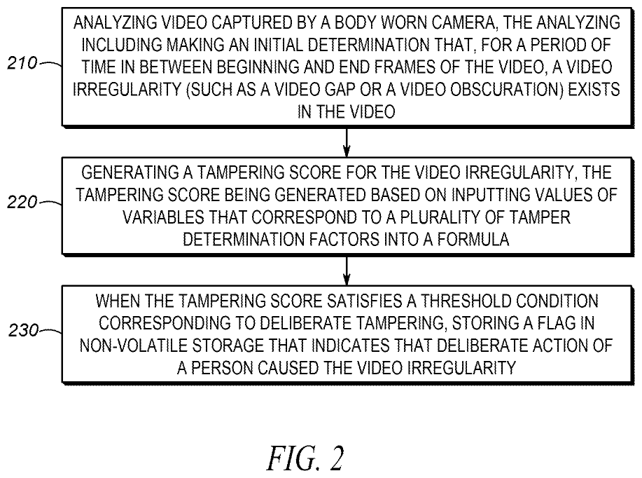

Reference is now made to FIG. 2. FIG. 2 is a flow chart illustrating a method 200 in accordance with an example embodiment.

In FIG. 2, the illustrated method 200 includes analyzing video (210) captured by a BWC (for example, as mentioned the mobile video recording device 104 may be a BWC). The video being analyzed includes an earliest-in-time video frame and a last-in time video frame that are captured at times t and t+Δt respectively. The action 210 includes employing at least one processor (for example, the processor 112 within the mobile video recording device 104, or one or more processors outside of the mobile video recording device 104) to make an initial determination that, for a time period in-between the times t and t+Δt, a video irregularity comprising a video gap or a video obscuration exists in the video (in some examples, this initial determination may be made contemporaneous with the t to t+Δt time period; however the initial determination may also be made at some later point in time after the t to t+Δt time period).

Next in the method 200, using the at least one processor, a tampering score for the video irregularity is generated (220). The tampering score is generated based on inputting values of variables that correspond to a plurality of tamper determination factors into a formula. The tamper determination factors include: one or more causes of the video irregularity; and one or more of at least one first factor directly perceivable from the video and at least one second factor not directly perceivable from the video. In some examples, the tamper determination factors may include at least two or more of the following: whether no video footage was being captured during the time period; whether no video footage being captured during the time period was due to the BWC being turned off; an extent to which video footage being captured during the time period was fully or partly obscured; an amount of motion of the video footage being captured during the time period; content alignment of the video footage being captured during the time period to another media source; and extent to which the time period is matching in time to an important partly missed or fully missed event.

Thus, an important partly missed or fully missed event may impact tampering score differently than a non-important partly missed or fully missed event. Examples of important events include those events inferable from media and other available video evidence such as, for instance, an officer purposely filming an act of discovering new evidence (when unknowing to the officer his BWC has actually captured him suspiciously putting the evidence in place during a time period, in respect of which the officer thought his BWC had been turned off, before a staged filming act), and also events not directly perceivable from video capture (such as, for instance, a weapon drawing event).

Next in the method 200, when the tampering score satisfies a threshold condition corresponding to deliberate tampering, a flag is stored (230) in non-volatile storage that indicates that deliberate action of a person caused the video irregularity. The non-volatile storage storing the flag may be, for example, the non-volatile storage 120 within the mobile video recording device 104; however the non-volatile storage could also be some other storage outside of the mobile video recording device 104. (Also, it will be understood that the person causing the video irregularity may be the user of the BWC; however it could also be someone else such as, for instance, someone nearby to the actual person that is wearing, or is expected to be wearing, the BWC.)

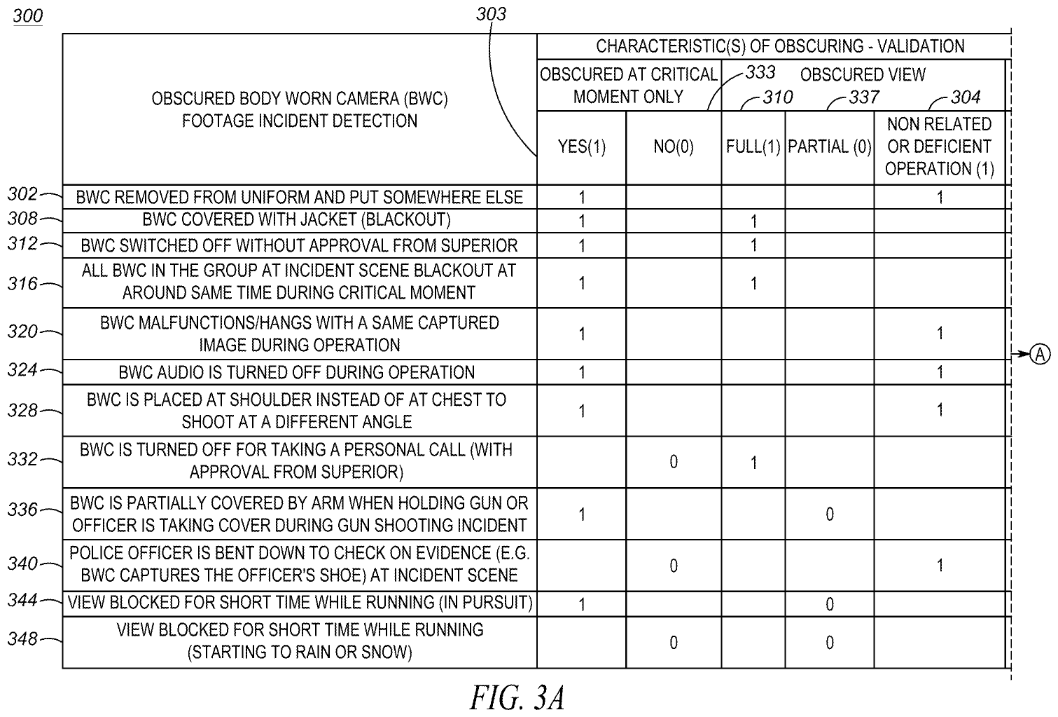

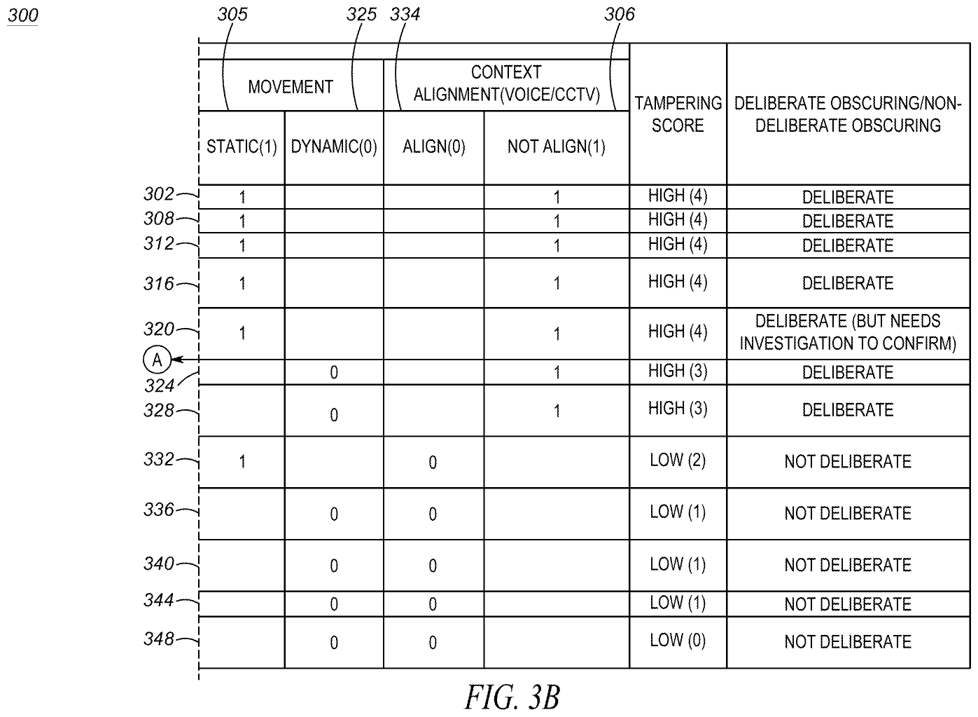

Reference is now made to FIGS. 3A-3B. FIGS. 3A-3B is a table 300 showing, in accordance with some examples of the method 200 of FIG. 2, tamper scoring for different types of video irregularity occurrences. It will be understood that while the table 300 relates to examples of relevant criteria for tamper scoring, any suitable criteria relevant to making a determination of flagging versus no flagging is contemplated. In connection with the table 300, it will be understood that a high tampering score (e.g. 3 and above) corresponds to deliberate tampering flagging and a low tampering scoring (e.g. 2 and below) corresponds to no flagging.

In the table 300, row 302 corresponds to the following type of video irregularity occurrence: “Body worn camera removed from uniform and put somewhere else.” A tampering score of four is generated based on the sum of one mark in each of columns 303, 304, 305 and 306. Because a tampering score of four is generated for this type of video irregularity, this type of video irregularity is flagged as deliberate tampering.

Row 308 corresponds to the following type of video irregularity occurrence: “Body worn camera covered with jacket (blackout).” A tampering score of four is generated based on the sum of one mark in each of columns 303, 310, 305 and 306. Because a tampering score of four is generated for this type of video irregularity, this type of video irregularity is flagged as deliberate tampering.

Row 312 corresponds to the following type of video irregularity occurrence: “Body worn camera switched off without approval from superior.” A tampering score of four is generated based on the sum of one mark in each of columns 303, 310, 305 and 306. Because a tampering score of four is generated for this type of video irregularity, this type of video irregularity is flagged as deliberate tampering.

Row 316 corresponds to the following type of video irregularity occurrence: “All body worn cameras in the group at incident scene blackout at around same time during critical moment.” A tampering score of four is generated based on the sum of one mark in each of columns 303, 310, 305 and 306. Because a tampering score of four is generated for this type of video irregularity, this type of video irregularity is flagged as deliberate tampering.

Row 320 corresponds to the following type of video irregularity occurrence: “Body worn cameras malfunctions/hangs with a same captured image during operation.” A tampering score of four is generated based on the sum of one mark in each of columns 303, 304, 305 and 306. Because a tampering score of four is generated for this type of video irregularity, this type of video irregularity is flagged as deliberate tampering; however, for this particular type of video irregularity occurrence the flag is not fully confirmed until a rare non-deliberate explanation is ruled out (e.g. diagnosis testing of the BWC is applicable here).

Row 324 corresponds to the following type of video irregularity occurrence: “Body worn camera audio is turned off during operation.” A tampering score of three is generated based on the sum of one mark in each of columns 303, 304 and 306. (It will be noted that the ‘0’ in column 325 does not increase or decrease the tampering score.) Because a tampering score of three is generated for this type of video irregularity, this type of video irregularity is flagged as deliberate tampering.

Row 328 corresponds to the following type of video irregularity occurrence: “Body worn camera is placed at shoulder instead of chest to shoot at a different angle.” A tampering score of three is generated based on the sum of one mark in each of columns 303, 304 and 306. (It will be noted that the ‘0’ in column 325 does not increase or decrease the tampering score.) Because a tampering score of three is generated for this type of video irregularity, this type of video irregularity is flagged as deliberate tampering.

Row 332 corresponds to the following type of video irregularity occurrence: “Body worn camera is turned off for taking a personal call (with approval from superior).” A tampering score of two is generated based on the sum of one mark in each of columns 310 and 305. (It will be noted that the zeros in columns 333 and 334 do not increase or decrease the tampering score.) Because a tampering score of two is generated for this type of video irregularity, this type of video irregularity is not flagged as deliberate tampering.

Row 336 corresponds to the following type of video irregularity occurrence: “Body worn camera is partially covered by arm when holding gun or officer is taking cover during gun shooting incident.” A tampering score of one is generated based on one mark in column 303. (It will be noted that the zeros in columns 337, 325 and 334 do not increase or decrease the tampering score.) Because a tampering score of one is generated for this type of video irregularity, this type of video irregularity is not flagged as deliberate tampering.

Row 340 corresponds to the following type of video irregularity occurrence: “Police officer is bent down to check on evidence (e.g. BWC captures the officer's shoe) at incident scene.” A tampering score of one is generated based on one mark in column 304. (It will be noted that the zeros in columns 333, 325 and 334 do not increase or decrease the tampering score.) Because a tampering score of one is generated for this type of video irregularity, this type of video irregularity is not flagged as deliberate tampering.

Row 344 corresponds to the following type of video irregularity occurrence: “View blocked for short time while running (in pursuit).” A tampering score of one is generated based on one mark in column 303. (It will be noted that the zeros in columns 337, 325 and 334 do not increase or decrease the tampering score.) Because a tampering score of one is generated for this type of video irregularity, this type of video irregularity is not flagged as deliberate tampering.

Row 348 corresponds to the following type of video irregularity occurrence: “View blocked for short time while running (starting to rain or snow).” A tampering score of zero is generated based on no marks (no ones) in any of the columns. (It will be noted that the zeros in columns 333, 337, 325 and 334 do not increase or decrease the tampering score.) Because a tampering score of zero is generated for this type of video irregularity, this type of video irregularity is not flagged as deliberate tampering.

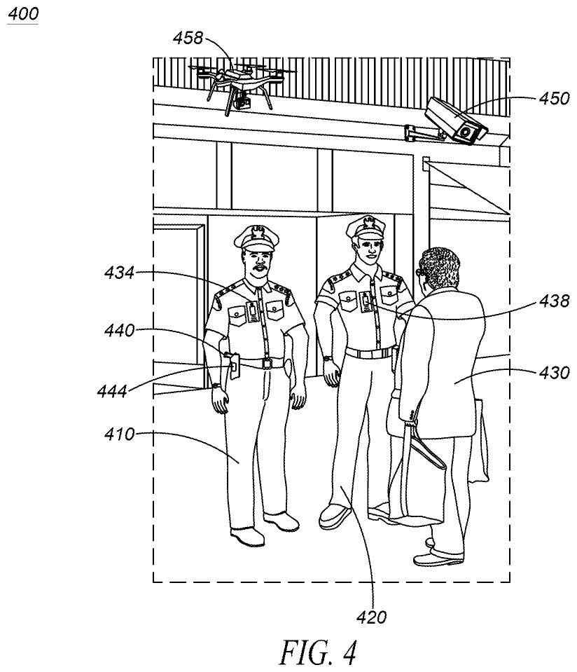

Reference is now made to FIG. 4 which shows an example incident scene 400 in accordance with an example embodiment.

Within the incident scene 400, a first police officer 410 and a second police officer 420 are interrogating a civilian 430. The first police officer 410 is wearing a BWC 434. The second police officer 420 is wearing a BWC 438. Each of the BWCs 434 and 438 can have the same hardware and software components already previously described in relation to the mobile video recording device 104 of FIG. 1 (i.e. each of the BWCs 434 and 438 may correspond to some suitable version of the mobile video recording device 104).

It will also be noted that the illustrated first police officer 410 is carrying a weapon 440. The weapon 440 includes a sensor 444, and via the sensor 444 it is possible to identify that, for example, the first police officer 410 (wearer of the BWC 434) has drawn the weapon 440 during the previously discussed t to t+Δt time period. Thus, the drawing of the weapon 440 may be one of the various possible tamper determination factors that have been discussed (i.e. a type of factor not directly perceivable from the video captured by the BWC 434).

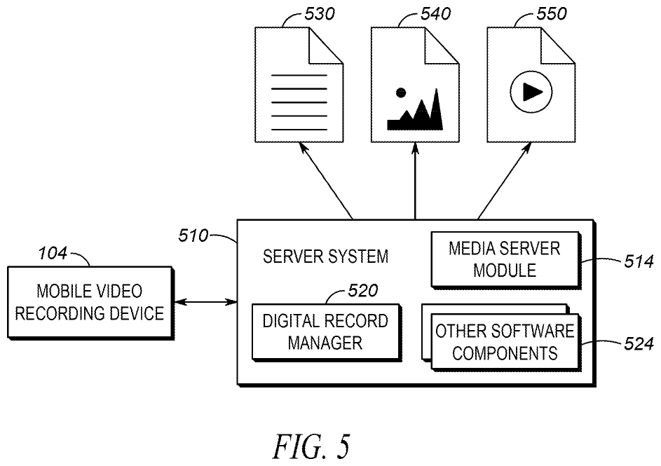

Reference is now made to FIG. 5, which is a block diagram showing the mobile video recording device 104 of FIG. 1 communicatively coupled to a server system 510 in accordance with an example embodiment. As will be appreciated by those skilled in the art, the communication between the mobile video recording device 104 and the server system 510 can be via a wired communications path (which may include for example, a cable, an intervening device dock in combination with cabling, etcetera), or alternatively the communication may occur over one or more networks. In the case of one or more networks, it is contemplated that this can include the Internet, or one or more other public/private networks coupled together by network switches or other communication elements. The one or more networks could be of the form of, for example, client-server networks, peer-to-peer networks, etc.

The server system 510 may be implemented in any suitable manner (for example, any of a local server system, a remote server system, a cloud implementation, or some combination of these is contemplated). The illustrated server system 510 includes a media server module 514. The media server module 514 handles requests related to delivery and formatting of video and images captured by cameras. The illustrated server system 510 also includes a digital record manager 520 as part of a digital record management system for providing controlled access to the video stored as video footage. The server system 510 also includes a number of other software components 524. These other software components will vary depending on the requirements of the server system 510 within the overall system. As one example, the other software components 524 might include special test and debugging software, or software to facilitate version updating of modules within the server system 510.

Different outputs from the server system 510 are contemplated. For example, the server system 510 may generate, as one type of possible output, an analytics report 530 that identifies deliberate tampering instances in relation to the BWC (and the generating of the analytics report 530 may include extracting the previously discussed stored flag or flags via the digital record management system). It is also contemplated that the server system 510 may generate other types of user-reviewable out such as, for example, image file(s) 540 and video file(s) 550. These image and video files may relate to, for example, highlights of incidents where images and video have been captured by BWC(s).

In some examples, non-volatile storage in the server system 510 (or some other server system) may store video and images captured by various cameras (for example, video and images captured by at least one the following: the BWC 434, the BWC 438, a fixed-location security camera 450 and a camera-equipped drone 458, or some other type of camera like, for instance, an in-vehicle camera). It is contemplated that a query may be initiated (sent to) such a server to identify these other camera(s) that captured respective other video within a defined same geographic area as the BWC, i.e. the BWC identified in respect of a video irregularity, at the incident within a defined time period. Thereafter, matching data corresponding to the query may be received from the server system that was queried.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot cause data to be stored in non-volatile storage, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method comprising:
analyzing video captured by a body worn camera, the video including an earliest-in-time video frame and a last-in time video frame that are captured at times t and t+Δt respectively, and the analyzing including employing at least one processor to make an initial determination that, for a time period in-between the times t and t+Δt, a video irregularity comprising a video gap or a video obscuration exists in the video;
generating, using the at least one processor, a tampering score for the video irregularity, wherein the tampering score is generated based on inputting values of variables that correspond to a plurality of tamper determination factors into a formula, and the tamper determination factors include: one or more causes of the video irregularity; and one or more of at least one first factor directly perceivable from the video and at least one second factor not directly perceivable from the video; and
when the tampering score satisfies a threshold condition corresponding to deliberate tampering, storing a flag in non-volatile storage that indicates that deliberate action of a person caused the video irregularity.

2. The computer-implemented method of claim 1 wherein the tamper determination factors include at least two or more of the following: whether no video footage was being captured during the time period; whether no video footage being captured during the time period was due to the body worn camera being turned off; an extent to which video footage being captured during the time period was fully or partly obscured; an amount of motion of the video footage being captured during the time period; content alignment of the video footage being captured during the time period to another media source; and extent to which the time period is matching in time to a partly or fully missed material event.

3. The computer-implemented method of claim 1 further comprising providing controlled access to the video stored as video footage via a digital record management system.

4. The computer-implemented method of claim 3 further comprising generating an analytics report that identifies deliberate tampering instances in relation to the body worn camera, and the generating the analytics report including extracting the stored flag via the digital record management system.

5. The computer-implemented method of claim 1 further comprising:
initiating a query to identify other cameras that captured respective other video within a defined same geographic area as the body worn camera during the time period; and
receiving matching data corresponding to the query from a server system.

6. The computer-implemented method of claim 5 wherein the tamper determination factors include the second factor not directly perceivable from the video which is at least a portion of the other video from an identified one of the other cameras.

7. The computer-implemented method of claim 5 wherein the other cameras include at least one of an in-vehicle camera, a drone camera and a fixed-location security camera.

8. The computer-implemented method of claim 5 wherein the other cameras include at least one other body worn camera.

9. The computer-implemented method of claim 1 wherein the initial determination is made contemporaneous with the time period.

10. The computer-implemented method of claim 1 further comprising:
identifying, via a sensor, that a wearer of the body worn camera has drawn a weapon during the time period, and
wherein the tamper determination factors include the second factor not directly perceivable from the video which is the wearer drawing the weapon during the time period.

11. A system comprising:
at least one processor; and
at least one electronic storage medium storing program instructions that when executed by the at least one processor cause the at least one processor to perform:
analyzing video captured by a body worn camera, the video including an earliest-in-time video frame and a last-in time video frame that are captured at times t and t+Δt respectively, and the analyzing including making an initial determination that, for a time period in-between the times t and t+Δt, a video irregularity comprising a video gap or a video obscuration exists in the video;
generating a tampering score for the video irregularity, wherein the tampering score is generated based on inputting values of variables that correspond to a plurality of tamper determination factors into a formula, and the tamper determination factors include: one or more causes of the video irregularity; and one or more of at least one first factor directly perceivable from the video and at least one second factor not directly perceivable from the video; and
when the tampering score satisfies a threshold condition corresponding to deliberate tampering, causing a flag to be stored in non-volatile storage, wherein the flag indicates that deliberate action of a person caused the video irregularity.

12. The system of claim 11 wherein the tamper determination factors include at least two or more of the following: whether no video footage was being captured during the time period; whether no video footage being captured during the time period was due to the body worn camera being turned off; an extent to which video footage being captured during the time period was fully or partly obscured; an amount of motion of the video footage being captured during the time period; content alignment of the video footage being captured during the time period to another media source; and extent to which the time period is matching in time to a partly or fully missed material event.

13. The system of claim 11 further comprising a digital record manager configured to facilitate controlled access to the video stored as video footage.

14. The system of claim 13 wherein executing of the program instructions by the at least one processor further causes generating an analytics report that identifies deliberate tampering instances in relation to the body worn camera, and the digital record manager is configured to extract the stored flag in support of the generating of the analytics report.

15. The system of claim 11 wherein executing of the program instructions by the at least one processor further causes:
initiating a query to identify other cameras that captured respective other video within a defined same geographic area as the body worn camera during the time period; and
receiving matching data corresponding to the query from a server system.

16. The system of claim 15 wherein the tamper determination factors include the second factor not directly perceivable from the video which is at least a portion of the other video from an identified one of the other cameras.

17. The system of claim 15 wherein the other cameras include at least one of an in-vehicle camera, a drone camera and a fixed-location security camera.

18. The system of claim 15 wherein the other cameras include at least one other body worn camera.

19. The system of claim 11 wherein the initial determination is made contemporaneous with the time period.

20. The system of claim 11 wherein executing of the program instructions by the at least one processor further causes:
identifying, via a sensor communicatively coupled to the at least one processor, that a wearer of the body worn camera has drawn a weapon during the time period, and
wherein the tamper determination factors include the second factor not directly perceivable from the video which is the wearer drawing the weapon during the time period.
